(19) United States
(12) Patent Application Publication
(10) Pub. No.: US 2004/0073436 A1
(43) Pub. Date: Apr. 15, 2004

(54) Service chain management system

(75) Inventor: Vick Vaishnavi, Danville, NH (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: OPTICOM, INC.

(21) Appl. No.: 10/268,479

(22) Filed: Oct. 10, 2002

(51) Int. Cl. G06F 17/60

(52) U.S. Cl. 705/1; 705/7

(57) ABSTRACT

The present invention provides a method for managing delivery of a service that includes an initial step of modeling the service delivery by defining selected attributes of and inter-relationships among four interacting components including a service provider, one or more customers of the service, technology required for delivering the service as well as one or more suppliers of that technology. The selected attributes and inter-relationships are then monitored, and performance metrics for assessing the quality of service delivery are generated based on the monitored attributes and inter-relationships.

### BACKGROUND OF THE INVENTION

The present invention relates generally to systems and methods for managing delivery of a service, and more particularly, to such systems and methods that employ models of inter-relationships among a plurality of elements required for service delivery to manage the services.

Many enterprises rely on a large number of resources for delivering services to their customers. Such resources typically interact with one another in a complex fashion to make the service delivery feasible. Managing these resources and their interactions so as to ensure that the customers receive an expected quality of service can be difficult. For example, supporting an e-business service can pose serious challenges to the technical staff of the service provider.

These difficulties will continue to increase substantially as the service support requirements, especially in Business-to-Business (B2B) services, extend well beyond the functionality of conventional products for managing systems and applications. In particular, the technical requirements for effective management of B2B service are quite daunting because B2B transactions typically require a level of network availability as well as performance predictability that are similar to those of telephony networks rather than enterprise or public internets. Further, each component in the transport path from the requesting client to the responding server must support these availability and predictability attributes.

Accordingly, there is a need for enhanced methods and systems for managing delivery of a service.

There is also a need for such methods and systems that can provide a user with information regarding the impact of one or more elements on the quality of service delivery.

### SUMMARY OF THE INVENTION

The present invention provides a method for managing delivery of a service that includes an initial step of modeling the service delivery by defining selected attributes of and inter-relationships among four interacting elements including a service provider, one or more customers of the service, technology required for delivering the service and one or more suppliers of that technology. The selected attributes and inter-relationships are then monitored, and performance metrics for assessing the quality of service delivery are generated based on the monitored attributes and inter-relationships. The term “service” is widely used and is generally known, and used herein to refer to one or more functions performed by a provider, typically called service provider, for some entity, typically called customer, based on an explicit or implicit agreement. A service may include, for example, access to the Internet, the use of a communications channel, a pre-defined telephone connection time, e.g., selected number of minutes per month, or other provision of or access to equipment or links.

In one aspect, the inter-relationship between a service provider and a customer is modeled by defining a Service Level Agreement (SLA) that describes metrics for measuring the quality of service delivery. Such metrics can indicate, for example, time periods for service availability, a level of expected service availability, the cost of service outage, or maximum allowable service outage within a selected time period.

In another aspect, the customers can be modeled as a plurality of hierarchically related sets of users of the service. The hierarchy can be defined, for example, based on geography or business demographics, or any other desired factor.

In yet another aspect, one or more software and hardware components associated with the technology for providing the service are modeled by defining one or more of their attributes and/or selected inter-relationships among them needed for delivering the service. For example, one attribute of a component can be defined to be one or more suppliers of that component. Another attribute of a hardware or a software component can relate to, for example, its associated supplier product type. Some examples of hardware and software components include, but are not limited to, network hosts, network servers, software applications, or database management systems.

In another aspect, a state variable is assigned to a service in order to signify the impact of the service provider, the customer, the technology for providing the service, or the supplier of the technology on service delivery. The state variable can have, for example, an “Up” value or a “Down” value to indicate that the service is operational or non-operational, respectively.

In other aspects, in a method of the invention for managing delivery of a service as described above, data is compiled regarding average repair time, average usage, traffic flow, and/or average down time associated with hardware and software components utilized for service delivery. The collected data can then be correlated to the state of the service. For example, if the down time of a hardware component exceeds a pre-defined threshold, the state of the service may be changed from “Up” to “Down.”

In further aspects of a method of the invention, scope identifiers are assigned to monitored information to limit access to the information to selected participants in the service delivery chain. A scope identifier can be, for example, globally unique and can identify, for each dataset, those participants who have authorization for viewing that dataset.

In a related aspect, the invention provides a system for managing service delivery that implements the methods of the invention described above. A system of the invention for managing delivery of a service can include a communication module that gathers information regarding a plurality of resources utilized for service delivery, and a consolidation module that receives this information to generate one or more consolidated datasets. The consolidated datasets relate to attributes and inter-relationships, defined by a model of service delivery, among the service provider, one or more customers of the service, technology for providing the service, and one or more suppliers of the technology. The system can further include a transformation layer that employs the consolidated datasets to generate one or more performance metrics for assessing the quality of service delivery.

In another aspect, a system of the invention as described above further includes an exchange module that communicates with the transformation layer to receive the metrics generated by the transformation layer, and generates reports regarding the quality of the service delivery based on these metrics. The reports can be presented in a variety of formats, such as, HTML, XML, CVS, RDBMS, or PDF.

Further understanding of the invention can be obtained by reference to the following detailed description in conjunction with associated drawings described briefly below.

### BRIEF DESCRIPTION OF THE DRAWINGS

FIG. 1 schematically depicts an exemplary architecture of a value chain model constructed in accordance with the teachings of the invention,

FIG. 2 schematically illustrates that a value chain model of the invention is formed by interaction of four elements in service delivery chain, namely, customer, provider, supplier and technology,

FIG. 3 schematically illustrates a structural model for an exemplary system of the invention for managing delivery of a service,

FIG. 4 schematically illustrates an exemplary data flow in a system of the invention,

FIG. 5 schematically illustrates a plurality of static and dynamic synthesizers provided in a transformation layer in a system of the invention for generating metrics for evaluating and managing service delivery,

FIG. 6 schematically illustrates the use of a system of the invention for monitoring and generating metrics relating to usage of an element utilized in service delivery,

FIG. 7 schematically illustrates the use of a system of the invention for monitoring and generating metrics regarding performance of a resource utilized for service delivery,

FIG. 8 schematically illustrates a subsystem of a system according to the teachings of the invention for service level assessment,

FIG. 9 schematically illustrates a relational data model employed by a system of the invention for storing and correlating information regarding various aspects of service delivery,

FIG. 10 schematically illustrates a company having four call centers whose productivity can be evaluated by utilizing the teachings of the invention,

FIG. 11 schematically illustrates switches and routers employed by the call centers depicted in FIG. 10,

FIG. 12 schematically illustrates comparison of the impact of two different routers utilized by two different call centers of FIG. 11 on performance of these call centers by utilizing the teachings of the invention,

FIG. 13 schematically illustrates comparison of the impact of two different switches employed by two different call centers of FIG. 11 on performance of these call centers by utilizing the teachings of the invention, and

FIG. 14 schematically illustrates comparison of the impact of a switch with that of a router on performance of two of call centers depicted in FIG. 11 by utilizing the teachings of the invention.

### DETAILED DESCRIPTION OF THE INVENTION

The present invention provides methods and systems for managing a service, such as, a web hosting service, by modeling the service delivery as a chain of inter-connected elements, herein also referred to as service value chain, that can include a service provider, one or more customers of the service, technology required for delivering the service, and the suppliers of the technology. As described in detail below, such a model can incorporate selected attributes of the elements and also the inter-relationships among these elements that are required for service delivery. These attributes and inter-relationships can then be monitored to generate performance metrics that allow assessing the quality of service delivery to provide information that can be utilized to improve the service quality.

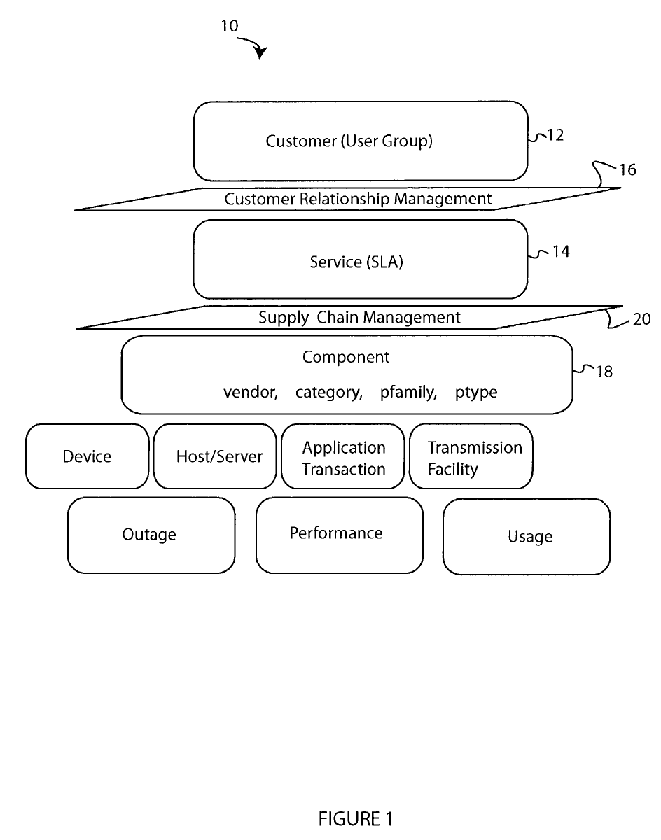

FIG. 1 schematically illustrates an exemplary architecture 10 of a value chain model constructed according to the teachings of the invention for managing a service provided to one or more customers. A customer 12 can be modeled as a collection of one or more user groups who are end users of the service. Each customer can have a name and other attributes that signify the business demographics associated with that customer. In some preferred embodiments, a model according to the invention can provide a hierarchical convention for naming multiple business units associated with a customer. By way of example, if the customer is an enterprise having a plurality of business units that are end users of the service, these business units can be named in a hierarchical fashion that readily identifies the inter-relationships among them. For example, if the customer of the service is an enterprise named Acme Corp. having a finance unit and a marketing unit, both of which are users of the service, the following naming convention can be utilized:

Customer Acme_Corp

Customer Acme_Corp.Finance

Customer Acme_Corp.Finance.Receivables

Customer Acme_Corp.Marketing

Customer Acme_Corp.Research

Customer Acme_Corp.Sales

The above naming convention for Acme Corp. allows creating a customer model that mimics the business inter-relationships among the various units, such as, the finance and the marketing units and the accounts receivables within the finance unit.

Each customer model can define one or more user groups, each of which subscribes to the service. The level and/or type of service provided to a user group can be the same or different than the service provided to another user group. By way of further illustration, in the above example regarding Acme Corp, the finance and the marketing units can belong to one user group and the research and the sale units can belong to another user group. The members within a user group are similarly affected by any changes in the service, e.g., service outage. In many embodiments of the invention, the number of members that belong to each user group is tracked in the customer model so as to allow determining some measure of customer impact when a change in the service, e.g., service outage, occurs.

With continued reference to FIG. 1, in some embodiments of the invention, the inter-relationship between a customer and a provider of the service can be at least partially modeled by an agreement 14, herein referred to as Service Level Agreement (SLA), reached between the customer and the service provider that spells out terms regarding acceptable levels of the service. That is, the provider and the customer may expressly formulate and agree upon the definition of an individual service. The terms of such an understanding, which can be memorialized in the SLA, may specify, for example, time periods during which the service is available, expected availability of the service, cost of down time, and dependency rules among service components. Thus, the SLA provides an interface for measuring the delivery of a service without a need to specify individual performance criteria for each component underlying the service delivery. This advantageously allows the customer and the provider to discuss the quality of service delivery based on the terms spelled out in the SLA, thus allowing the service provider to maintain a certain level of opacity regarding the details of service delivery.

A relationship layer 16 provides an interface between a service model, such as a model provided by an SLA, and a customer model to allow the exchange of service information between the service provider and the customer. This layer can also allow integration of a system of the invention for managing service delivery with Customer Relations Management (CRM) systems.

The delivery of a service generally requires a variety of technologies and their associated hardware and software components. Some examples of such components include, but are not limited to, network devices, network hosts, network servers, a variety of software applications and database management systems, data transmission facilities, such as leased lines, links, circuits, and computing and storage resources. In a method of the invention, the role of such technologies in service delivery is defined by a component model 18 of the hardware and software components associated with these technologies. A component model can specify, for example, selected attributes of that component, and can further define the inter-relationship of that component with others required for a successful service delivery chain.

A component model can assign the component a vendor attribute that identifies one or more suppliers of that component, and it can classify the component by its associated supplier product family and/or product type. In preferred embodiments of the invention, component models include component data attributes that can specify factors contributing to the service delivery. For example, a “Usage” data attribute associated with a component model can identify usage data record for the component, and an “Outage” attribute can identify an event associated with that component that can contribute to downtime or deterioration of service delivery. Further, a “Performance” attribute can identify the responsiveness of a component within pre-defined control limits. Dynamic data sets can also be provided that relate to other attributes defined independently of the above exemplary attributes, or can be derived from or be defined as combination of the above attributes.

The service provider and the suppliers of hardware and software components required for service delivery can share information provided by the component model and their contributions to the quality of service delivery via an interface layer 20 that allows communication and/or integration of a system of the invention with pre-existing supply chain management (SCM) systems.

In a method of the invention for managing service delivery, the technology component models can be generated based on the underlying management system utilized for managing these components. For example, a component model according to the teachings of the invention can employ the semantics used in the underlying component management system to refer to the component and/or to assign various service attributes and classification rules associated with that component. Alternatively, normalized semantics can be employed to produce homogeneous component models independent of the incumbent component management systems.

In some embodiments of the invention, metrics for measuring service availability are generated based on the terms of a Service Level Agreement reached between the customer and the service provider in combination with dependency rules among the components required for service delivery. These metrics then dictate the type of component data to be collected and analyzed to produce metric values that can indicate the quality of the service delivery. To expedite generating the metric definitions, a plurality of default metrics can be provided that can be utilized in their original form or be readily modified to produce a set of desired metrics for a particular service.

A variety of methods can be employed for monitoring selected attributes of the hardware and software components associated with a service for generating metrics related to quality of service delivery. For example, simple network management protocol (SNMP) can be employed to monitor a variety of devices, e.g., routers, that form a computer network. Other protocols for monitoring network devices can include, for example, TL1, CLI, and RS232 based CLI.

The data collected from the components is then analyzed and converted into a plurality of metrics that readily indicate how well the service is performing, and if the performance is below an acceptable threshold. Some metrics can identify those components, if any, that may be causing deterioration in service delivery. In particular, cross-correlations among various data sets are provided so as to determine the cause of a service deterioration or outage without a need to sift through a large amount of data. For example, in a service that employs a multitude of servers and other network components, such cross-correlations of various data sets can readily indicate that the slow response time of a server that is caused by exceeding high utilization of server disk (e.g., utilization exceeding 99.99%) has led to the deterioration of service delivery. Further details regarding methods and systems for service monitoring suitable for use in the practice of the present invention can be found in a co-pending U.S. patent application of the assignee of the present application entitled “Service Monitoring and Reporting System,” having a Ser. No 10/113,199, filed Mar. 28, 2002, and herein incorporated by reference in its entirety.

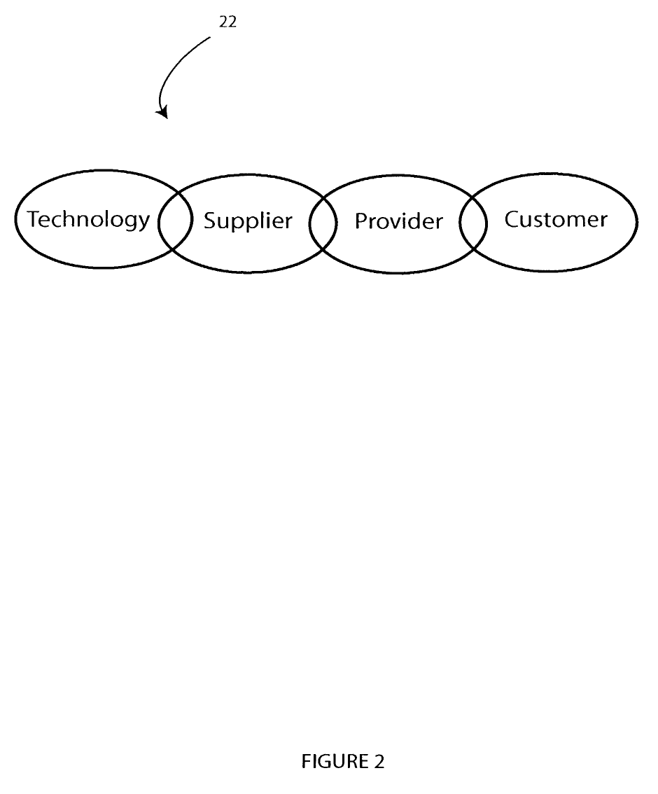

Thus, as shown schematically in FIG. 2, the methods of the invention as described above allow modeling the service delivery as a chain 22 having four inter-connected elements or links, namely, customer, provider, supplier and technology. This advantageously allows managing the service delivery by utilizing business oriented management models.

In some embodiments of the invention, a state variable, for example, a state machine, is assigned to the service chain model whose value (or instantaneous state) provides a deterministic view of service delivery. For example, a binary state machine having “Up” and “Down” states can be utilized to indicate, based on calculated metrics, whether the service is functional, i.e., it is “Up,” or a service outage has occurred, i.e., the service is “Down.” Such a state machine can include more than two states. For example, a third state can indicate that a service outage has occurred, and repair is in progress for restoring the service functionality. Those having ordinary skill in the art will appreciate that many other states can be defined to provide a deterministic view of the mode of service delivery.

The information regarding service delivery generated according to the invention, including various performance metrics, can be disseminated to the participants along the service management chain, such as, the service provider and the customers. In particular, business management metrics can be shared as well as integrated with pre-existing business management systems, such as, CRM and SCM systems. The data generated by the methods of the invention can be presented in a variety of different formats. Such presentation formats can include, but are not limited to, hypertext mark-up language (HTML), extended mark-up language (XML), portable document format (PDF), comma-separated values (CSV), or relational database management system (RDBMS). The data can also be presented in the form of reports that can be generated periodically, for example, daily, weekly, monthly, or yearly.

In some embodiments of the invention, the data corresponding to the quality of service delivery, obtained in accord with the methods of the invention described above, can be organized based on a set of rules that establish a policy. The policy can be defined based on various criteria that can include, but are not limited to, the structure of an organization, geography, location of selected participants in the service management chain, names of selected entities, or inter-relationships among selected entities. That is, different portions of the data can have different scopes. For example, such a policy can define, for each participant in the service management chain, those portions of the data to which that participant has access. For example, a customer may have access to performance metrics related to various terms of a Service Level Agreement, but not to the metrics related to performance of individual hardware and software components. Methods and systems for associating a dataset with a given policy suitable for use in the practice of the present invention can be found in a co-pending patent application of the assignee of the present invention entitled “User-Scope-Based Data Organization System,” having a Ser. No. 09/943,410, filed Aug. 30, 2001, and herein incorporated by reference in its entirety.

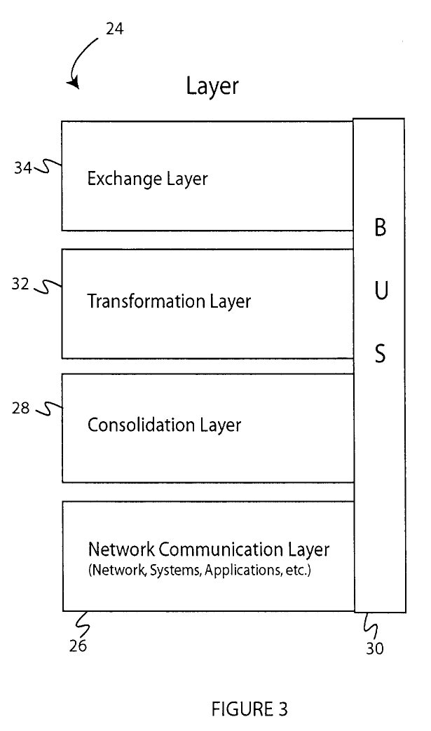

FIG. 3 schematically illustrates a structural model for an exemplary system 24 of the invention for managing delivery of a service. The system 24 includes a network communications layer 26 that can mine data from a variety of sources, such as, network and/or database management systems. In addition, the layer 26 can normalize the retrieved data to a common format. For example, the communications layer may retrieve information regarding two routers by two different management systems in different formats although the routers are manufactured by the same supplier. The communications layer can normalize the information associated with the two routers to indicate that both are manufactured by the same supplier.

The network communications layer 26 can communicate with a variety of commercially available network and database management systems, such as, SQL database management systems and a network management system marketed by Hewlett Packard company of Palo Alto, Calif., U.S.A. under tradename OpenView. Further details regarding data mining methods and systems suitable for use in a system of the invention can be found in a U.S. patent application entitled “Method and Apparatus for Collection and Normalization of Data,” having a Ser. No. 09/616,574, filed Jul. 14, 2000, and assigned to the assignee of the present application. This patent application is herein incorporated by reference in its entirety.

Not only can the communications layer 26 retrieve data from various sources, e.g., management systems, but it can also transmit commands, if needed, to these management systems to provision one or more components. More particularly, the communication layer 26 can translate normalized provisioning functions utilized in the system of invention into management commands recognizable by external management systems. For example, a CMD command for configuring a router can be translated to CREATE_MODE1, which is a network management system (NMS) terminology.

With continued reference to FIG. 3, a consolidation layer 28 can receive the information retrieved by the communications layer 26 via a bus 30, and can combine this information into consolidated data sets. For example, the consolidation layer 28 can generate data relating to inventory, usage of selected components, performance, events, e.g., outages, or any other desired category. In many embodiments, a consolidation layer allows a user to dynamically define any desired consolidation criteria. The consolidators can be designed to compile data sets useful for generating metrics that allow assessing quality of service delivery based on a model according to the teachings of the invention, as described above. Further, the consolidation layer can distribute provisioning data via the communications layer to various external systems.

The exemplary system 24 also includes a transformation layer 32 that utilizes a plurality of synthesizers to analyze the consolidated data in order to generate metrics for evaluating the service quality. The synthesizers can be pre-defined to perform a special task, e.g., generating correlations among two data sets, or alternatively, they can be dynamically configured by the system user to perform a desired analysis.

The transformation layer can also generate provisioning data based on a pre-defined policy, and transmit the provisioning data via the consolidation and communications layer to external management systems. For example, the transformation layer can generate commands for configuring a router, and can transmit these commands to the consolidation and communications layers.

An exchange layer 34 employs the information generated by the transformation layer to generate reports in a variety of formats that can be utilized by participants in the service delivery chain to evaluate various aspects of service delivery. The exchange layer can generate the reports in a variety of formats, such as, HTML, XML, PDF. Further, the reports can be generated in formats that are compatible with various database management systems, such as, relational or object-oriented database systems. The exchange layer 34 can also accept input from users and/or external systems.

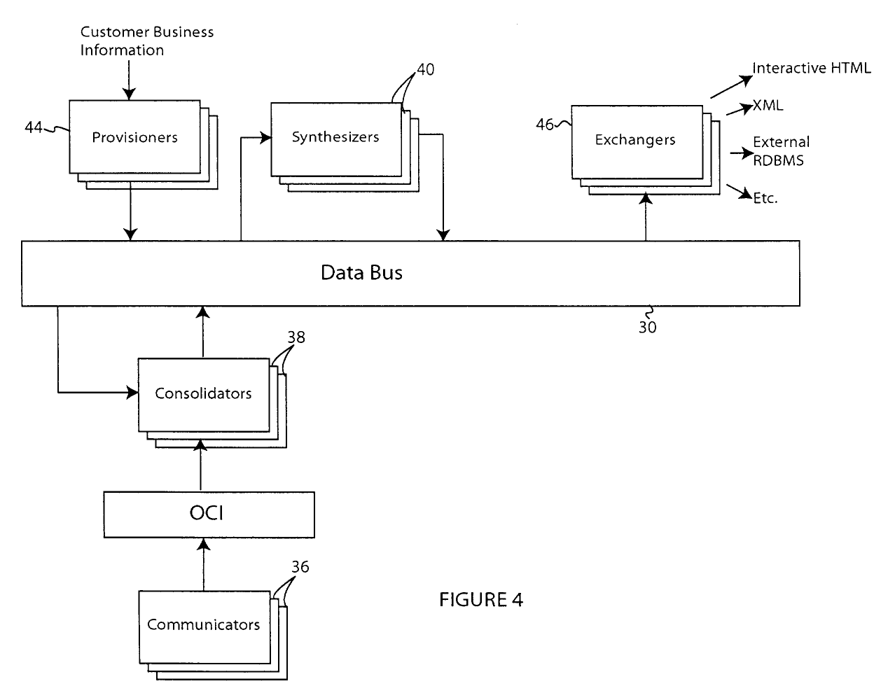

FIG. 4 schematically illustrates an exemplary data flow through the above system 24 of the invention in which a plurality of communicators 36 in the network communication layer 26 gather information regarding various aspects of service delivery. The communicators can utilize a variety of protocols to obtain the desired information. For example, a communicator can be designed to employ SNMP (Simple Network Management Protocol) protocol to obtain network management data from one of more components, e.g., computer, router, etc, forming a computer network. Alternatively, a communicator can be designed to communicate with a pre-existing business management system and/or a variety of database systems, e.g., relational or object oriented, to retrieve selected information therefrom. The communicators can also be configured to transmit provisioning data and commands to such external systems.

With continued reference to FIG. 4, the communicators 36 transmit the data obtained from multiple sources to a plurality of consolidators 38 provided in the consolidation layer 28. The consolidators 38 can employ a variety of different protocols for such data transmission. In this exemplary embodiment, an Open Computer Interface (OCI) protocol is utilized. The consolidators arrange the received data into a plurality of data sets suitable for performing analysis of service delivery. For example, one consolidator may utilize the information regarding outages of a selected component in an external network to provide an outage log of that component. Another consolidator may generate an inventory log. As mentioned above, the consolidators can be designed to generate data sets suitable for creating metrics, defined by a service delivery model according to the teachings of the invention as described above, that allow assessing the quality of service delivery.

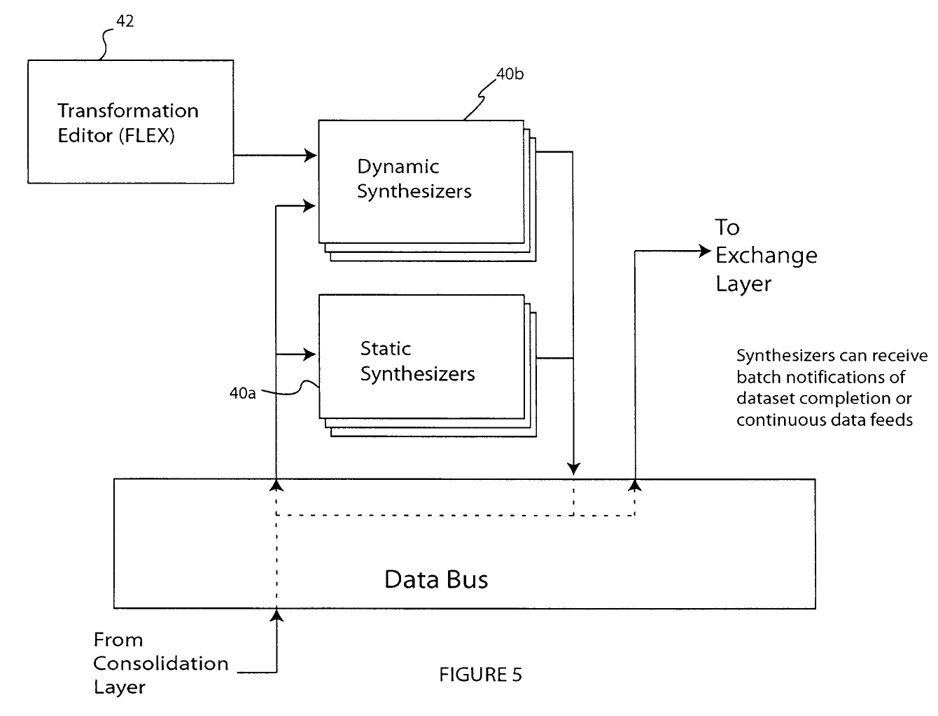

The data sets generated by the consolidators are then transmitted via the data bus 30 to a plurality of synthesizers 40 in the transformation layer 32 to be analyzed in order to generate metrics suitable for evaluating and managing service delivery. As shown in FIG. 5, in this exemplary embodiment, the transformation layer 32 includes a plurality of static synthesizers 40a and a plurality of dynamic synthesizers 40b. Each static synthesizer 40a can employ a pre-defined set of instructions for analyzing one or more data sets. For example, a static synthesizer can generate correlations among selected data sets. By way of example, the synthesizer can correlate the average response time of a server with data relating to utilization of storage space on that server. A dynamic synthesizer can be dynamically configured by the system user to generate a desired analysis of the data sets. In particular, a transformation editor 42 can be utilized to configure one or more dynamic synthesizers for analyzing selected data sets received from the consolidation layers.

Not only can a system of the invention retrieve data from a variety of external systems for analysis and assessment of service delivery, but it can also transmit data and/or commands to such systems. For example, referring again to FIG. 4, a plurality of provisioners 44 can be utilized to transmit provisioning data and/or commands to one or more external systems, e.g., a router in an external computer network, via the consodilators 38.

With continued reference to FIG. 4, the metrics generated by the synthesizers can then be transmitted via the bus 30 to a plurality of exchangers 46 that generate reports based on these metrics. The exchangers can communicate with a variety of user interfaces and external applications, and can format the reports to be compatible for viewing with these user interfaces, e.g., a web browser, and/or for distribution to these external applications, e.g., database management systems.

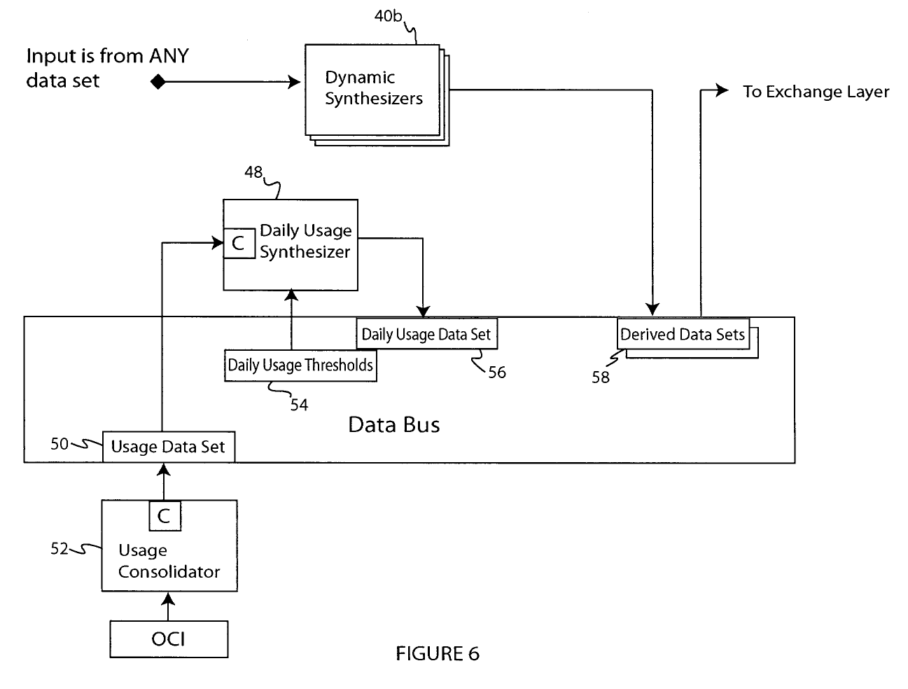

The system architecture described above can be utilized to monitor and to generate metrics regarding many aspects of service delivery. For example, FIG. 6 schematically illustrates the use of the system 24 for monitoring and generating metrics relating to usage of a component, e.g. a router, utilized in service delivery. In particular, a Daily Usage synthesizer 48 in the transformation layer receives a usage data set 50 corresponding to that resource compiled by a usage consolidator 52, and employs the usage data together with pre-defined daily usage thresholds 54 to generate a daily usage data set 56. The daily usage data set provides metrics for evaluating the level of usage of the component. For example, such a metric may indicate that the traffic flow through the router is within 90% of an allowable maximum load during certain hours in the day.

Further, one or more of the dynamic synthesizers 40b can be configured to utilize input data relating to capacity together with one or more usage data sets generated by the usage synthesizers to generate derived data sets 58 representing other desired metrics relating to usage and capacity.

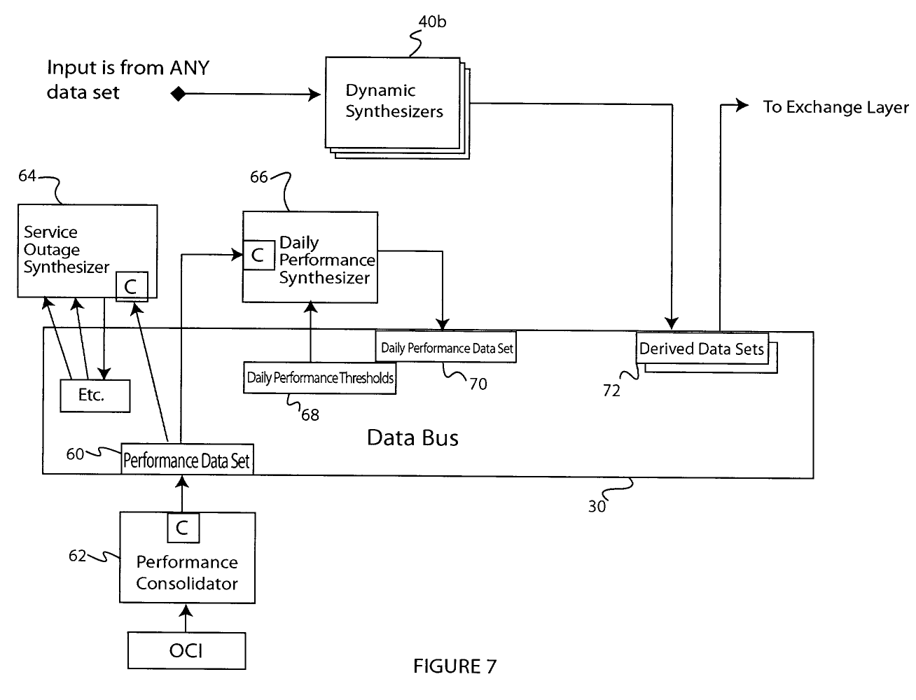

As another example, FIG. 7 schematically displays the use of the system 24 for monitoring and generating metrics regarding performance of a resource, e.g., a hardware component, utilized for service delivery. A performance data set 60 compiled by a performance consolidator 62 in the consolidation layer can be transmitted via the bus 30 to a service outage synthesizer 64 and a daily performance synthesizer 66 present in the transformation layer 32. The daily performance synthesizer 66 employs the received consolidated data set in conjunction with pre-defined daily performance thresholds 68 to generate a daily performance data set 70 representing selected performance metrics. In addition, one or more of the dynamic synthesizers 40b can utilize other performance data, either individually or in combination with one or more performance data sets generated by the performance synthesizers, to produce derived data sets 72 representing performance metrics.

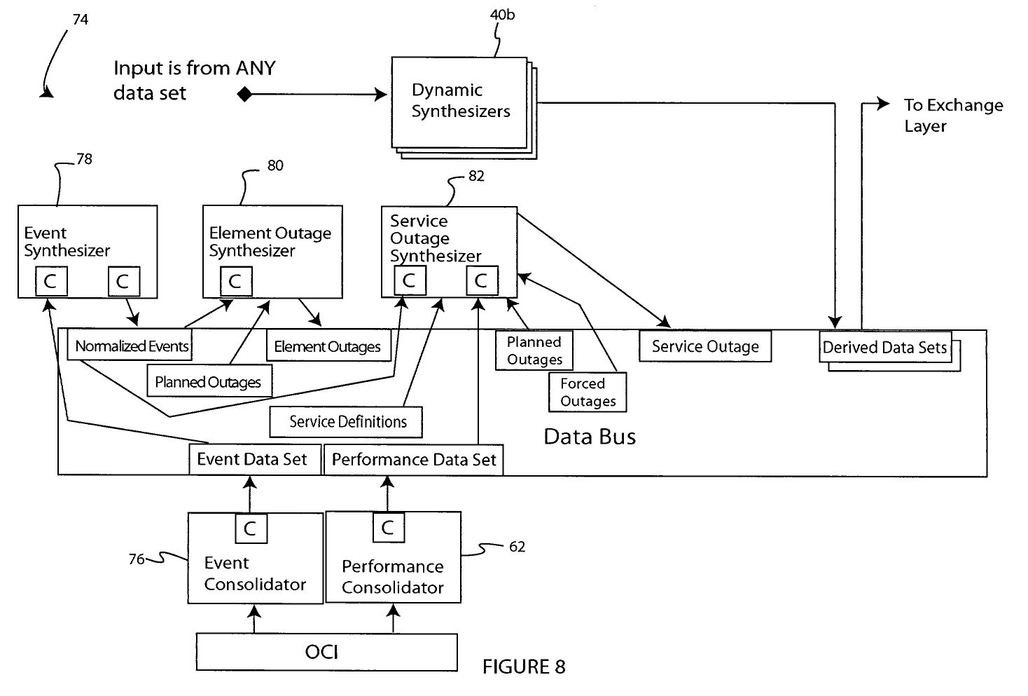

FIG. 8 schematically depicts a subsystem 74 of the exemplary system 24 for service level assessment. The subsystem 74 includes an event consolidator 76 that compiles data received from the network layer (See FIG. 3) into an event data set 78. An event can signify, for example, outage of a component, configuration failure, software violation, and security breach. Those having ordinary skill in the art will appreciate that other events can also be defined. The event data set compiled by the event consolidator 76 is transmitted via the bus 30 to an event synthesizer 78 that transforms the event data set into normalized events, and transmits the normalized events to an element outage synthesizer 80 and a service outage synthesizer 82. That is, the event synthesizer 78 transforms events of varying formats from various NMS systems into a common data format, and transmit the normalized events to the element and system outage synthesizers. The element outage synthesizer 80 employs the normalized events in conjunction with planned outages, e.g., a server being down for routine scheduled maintenance, to generate information indicative of outages of selected elements. Further, the performance consolidator 62 compiles a performance data set based on performance data received from the network layer, and transmits the performance dataset to the service outage synthesizer. The performance consolidator 62 can be provisioned to generate a performance data set based on a model of service delivery. For example, a performance consolidator can generate a data set relating to response time of a particular server utilized as part of the technology infrastructure for delivering a service.

With continued reference to FIG. 8, the service outage synthesizer 82 generates service outage data by utilizing a set of service definitions together with the element outage data set and performance data set. Moreover, the service outage synthesizer takes into account planned outages, i.e., routine schedules outages, and forced outages in generating the service outage data. The term “forced outage” is used herein to refer to an outage that the synthesizer is asked to recognize, for example, by the system administrator, although the received data does not indicate such an outage. This can occur, for example, when fault recognition systems fail to recognize the outage of one or more systems required for service delivery.

A plurality of dynamic synthesizers 40b can utilize input data from selected data sets relating to service outage individually or in combination with the service outage metrics generated by the service outage synthesizer to produce derived data sets relating to service outages. The datasets can be transmitted to the exchange layer for generation of reports, as discussed in detail above.

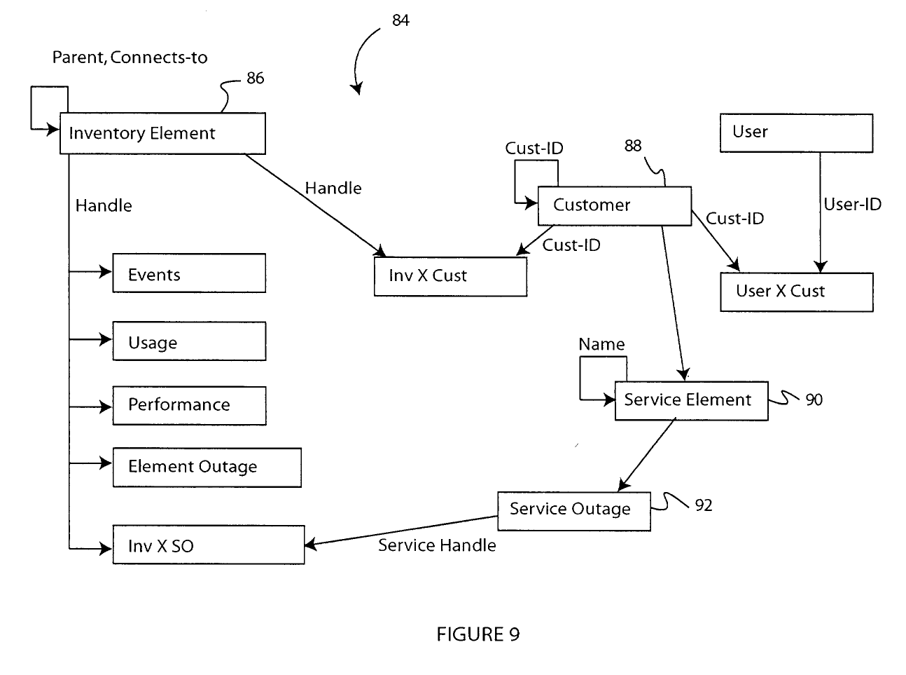

FIG. 9 schematically illustrates a relational data model 84 for storing and correlating information regarding various aspects of service delivery in a system of the invention. An inventory element 86, for example, a router, can be associated with a set of attributes, such as, usage, events, performance, element outage, and service outage, via one or more identifiers or handles. Further in the model 84, a customer 88 can be associated with a service element 90 that the customer utilizes as well as with the inventory element needed for supplying the service. A failure of the inventory element can cause an outage of the service element, which in turn can cause a service outage 92. The illustrated data model allows associating such a service outage with a failure of the inventory element. In addition, the exemplary data model allows associating a system user, e.g., a service provider, to be associated with the customer utilizing the service.

A variety of programming languages, e.g., C, C++, Java, Perl, and standard software engineering practices can be employed to generate various modules, e.g., consolidators or synthesizers, of the above exemplary systems.

A suitable commercially available system that can be configured to perform the methods of the invention for managing delivery of a service is manufactured by Opticom Inc. of Andover, Massachusetts, U.S.A under trade designation iView.

The following examples provide further understanding of the invention, and are provided only for illustration of the salient features of the invention.

### EXAMPLE 1

In this example, a SAP service provider delivers the service to selected customers over a T-1 link that employs an ATM-PVC as the underlying transport link provisioned over an ATM switch obtained from a vendor A. This service can be modeled as a chain of inter-related attributes of various components in service chain delivery in accordance with the teachings of the invention as described above. The modeled attributes can be monitored to obtain data for generating selected performance metrics. For example, the responsiveness of the SAP client and server as well as the cell transfer rate through the PVC and the availability of the switch can be monitored.

The impact of each monitored attribute on the overall availability of the SAP service can also be determined. Each participant in the service chain delivery is provided access to information regarding various aspects of service delivery based on the monitored attributes. For example, the service provider can determine which customers were affected by a service outage, or whether a deterioration of the SAP response is due to congestion on the client or the server side, and more importantly, the cause of the congestion. For example, the data and the correlations provided by a system of the invention can allow the service provider to determine whether the congestion is due to over-utilization of the server CPU, a low available storage capacity on the client disk, or cell loss experienced by the ATM-PVC. In addition, a system of the invention allows a user to change the context of management view by switching to any of the linkages in the service chain.

### EXAMPLE 2

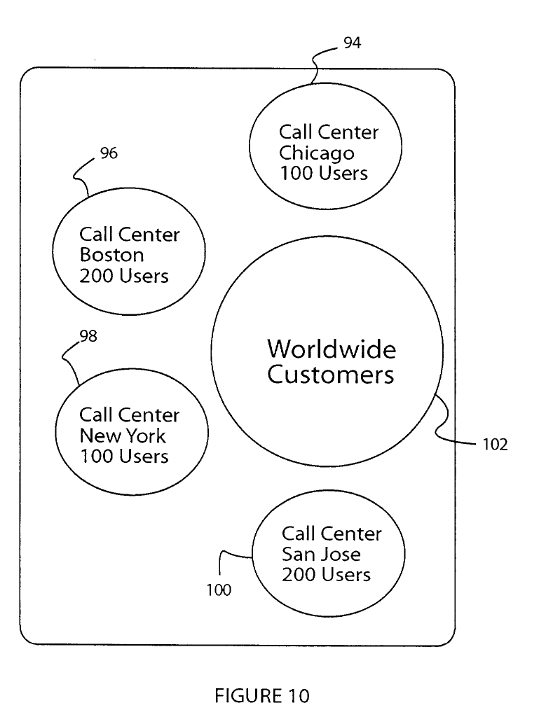

With reference to FIG. 10, a company can have exemplary call centers 94, 96, 98, and 100, each of which utilizes some CRM application to book orders as well as support the company's worldwide customers 102. An executive of the company can employ systems and methods of the invention to generate metrics, such as, call volume or ratio of calls to orders, to measure the productivity of each center.

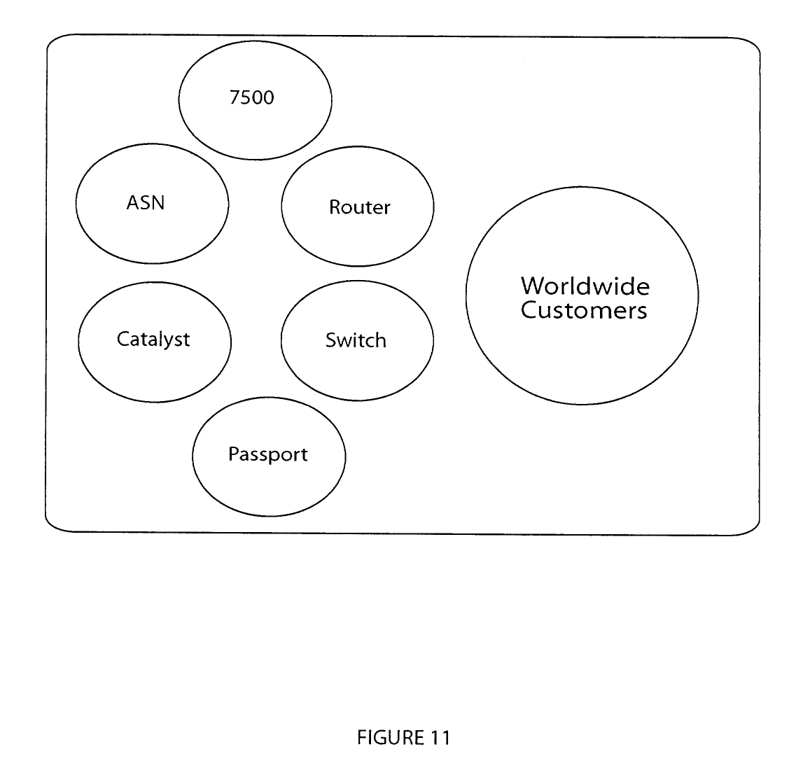

Let us assume that the CRM application employs a mixed routed and switched environment as the underlying communication layers in this company. For example, with reference to FIG. 11, routers of type 7500 and ASN and switches of type catalyst and passport can be employed. Further the company obtains the switch and the router from two suppliers, for example, “Cisco” and “Nortel.” In this example, the Chicago and New York centers employ the 7500 and ASN routers, respectively, and the Boston and San Jose centers employ the Catalyst and the Passport switches, respectively.

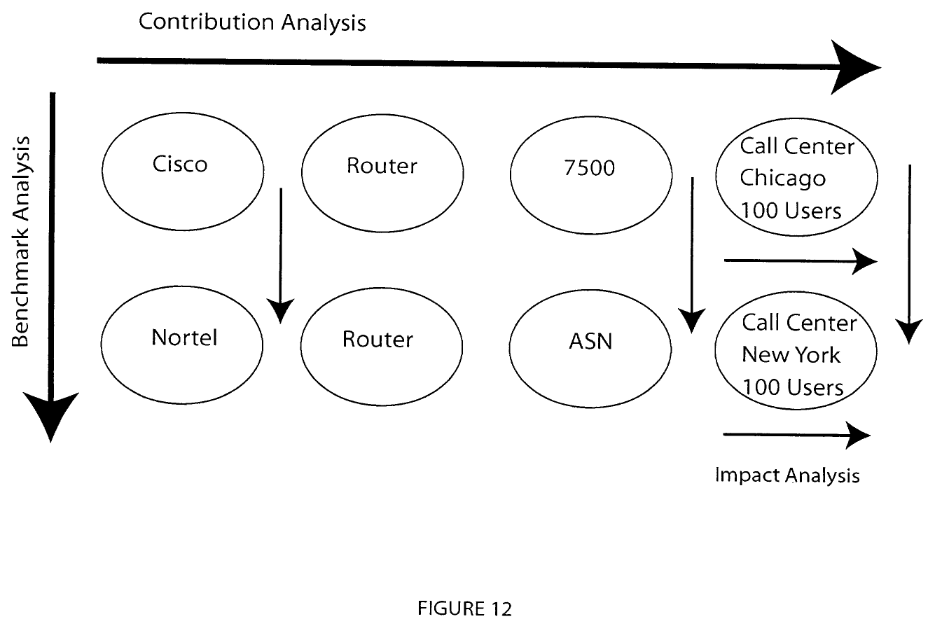

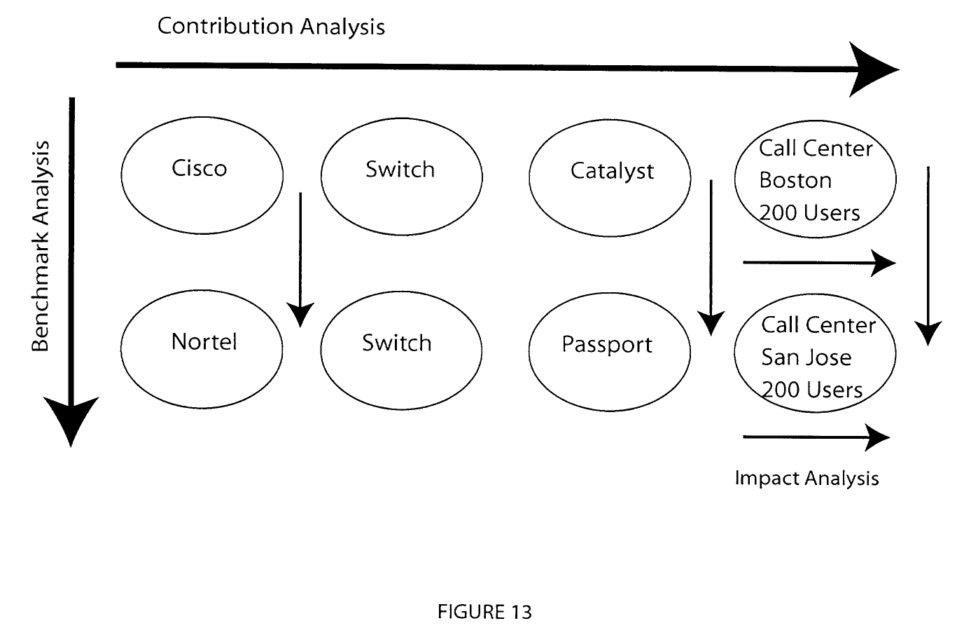

As shown schematically in FIG. 12, a service chain management system of the invention allows the executive to compare the impact of the 7500 router on the performance of the Chicago center with that of the ASN router on the performance of the New York center by generating performance metrics, such as, the average outage time in a selected time interval, and correlating these metrics. Similarly, as shown schematically in FIG. 13, the impacts of the catalyst and the passport switches on the performances of the Boston and San Jose centers can be compared.

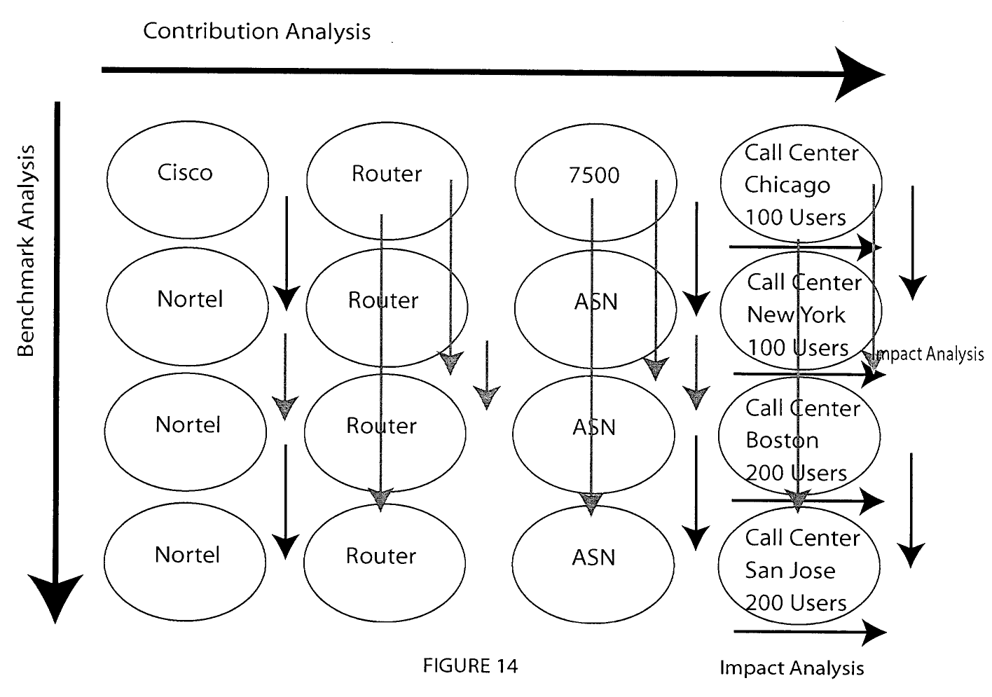

Further, as shown schematically in FIG. 14, the systems and the methods of the invention also allow the executive to compare the impact of a router with that of a switch on the respective performances of two call centers, one of which utilizes a routed network and the other a switched network. Such a comparison can be obtained across the same or different suppliers. This advantageously allows the executive to obtain a global view of the performance characteristics of all call centers including those that do not employ similar communications infrastructure.

Those having ordinary skill in the art will appreciate that various modifications can be made to the above embodiments without departing from the scope of the invention. All cited references are incorporated herein in their entirety.

What is claimed is:

1. A method of managing delivery of a service, the method comprising the steps of:
modeling service delivery by defining a plurality of attributes and interrelationships among at least four interacting elements comprising service provider, one or more customers of said service, technology for providing the service, and one or more suppliers of said technology,
monitoring said attributes and inter-relationships associated with each of said elements, and
generating performance metrics based on said monitored attributes and inter-relationships to assess quality of service delivery.

2. The method of claim 1, further comprising modeling the relationship between the service provider and said customers by defining at least one Service Level Agreement describing metrics for measuring service delivery.

3. The method of claim 2, further comprising selecting one of said metrics defined by the Service Level Agreement to indicate any of time periods for service availability, a level of expected service availability, a cost of service downtime, or a maximum allowable service down-time within a selected time period.

4. The method of claim 1, wherein the step of modeling service delivery further comprises modeling said customers as one or more hierarchically related sets of users of said service.

5. The method of claim 4, wherein said user sets are defined based on a geographical hierarchy.

6. The method of claim 4, wherein said user sets are defined based on business demographic.

7. The method of claim 1, wherein said step of modeling service delivery further comprises modeling one or more software and hardware components associated with said technology and inter-relationships among said hardware and software components required for delivering the service.

8. The method of claim 7, wherein said step of modeling service delivery further comprises associating each of said hardware and software components with at least one supplier of said component.

9. The method of claim 7, wherein said step of modeling service delivery further comprises classifying each of said hardware and software components by its associated supplier product type.

10. The method of claim 1, further comprising assigning a state variable to said service signifying impact of any of said four components on service delivery.

11. The method of claim 10, further comprising assigning an “Up” value to said state variable to indicate that the service is operational and assigning a “Down” value to said state variable to indicate that the service is non-operational.

12. The method of claim 7, wherein said step of monitoring further comprises compiling data regarding any of average repair time, average usage, traffic flow, and average down-time associated with said hardware and software components.

13. The method of claim 10, further comprising correlating said compiled data to the state of said service.

14. The method of claim 7, further comprising correlating said attributes to the state of said service.

15. The method of claim 6, further comprising the step of assigning a scope identifier to one or more of said hardware or software component models.

16. The method of claim 13, further comprising selecting said scope identifier to be globally unique.

17. The method of claim 7, further comprising selecting said software and hardware components to be any of network hosts, network servers, software applications or database management systems.

18. The method of claim 10, further comprising correlating a change in a state of the service with customers affected by that change.

19. A system for managing delivery of a service, comprising
a communication module for gathering information regarding a plurality of resources utilized for service delivery,
a consolidation module in communication with said communication module for receiving said information to generate one or more consolidated data sets relating to attributes and inter-relationships among four interacting elements comprising service provider, one or more customers of said service, technology for providing the service, and one or more suppliers of said technology, said attributes and inter-relationships being defined by a model of service delivery, and
a transformation module in communication with said consolidation module to generate one or more performance metrics for assessing the service delivery based on said consolidated data sets.

20. The system of claim 17, further comprising an exchange module in communication with said transformation module, said exchange module generating reports regarding quality of service delivery based on said metrics.

21. The system of claim 17, wherein said transformation module generates said metrics by calculating correlations among two or more of said consolidated data sets.

22. The system of claim 18, wherein said exchange module generates each of said reports in a selected presentation format.

23. The system of claim 20, wherein said selected presentation format can be any of HTML, XML, CSV, RDBMS and PDF.

24. The system of claim 17, wherein said communication module communicates with one or more external management systems to retrieve information regarding said resources.

25. The system of claim 22, wherein said external management system can be any of a database management system, a computer network management system.
